(19) United States
(12) Patent Application Publication
(10) Pub. No.: US 2017/0101161 A1
(43) Pub. Date: Apr. 13, 2017

(54) BICYCLE DRIVE MECHANISM TO ENABLE COASTING

(71) Applicants: Alon COHEN, Haifa (IL); Tal MAZAR, Modiin (IL)

(72) Inventors: Alon COHEN, Haifa (IL); Tal MAZAR, Modiin (IL)

(21) Appl. No.: 14/878,119

(22) Filed: Oct. 8, 2015

(51) Int. Cl. B62M 11/02; B62M 1/36; F16D 41/12; F16H 1/28

(52) U.S. Cl. CPC B62M 11/02; F16H 1/28; B62M 1/36; F16D 41/12

(57) ABSTRACT

A drive mechanism to enable a bicycle to coast forward or backward iincludes a ratchet ring that is directly coupled to a sprocket of the bicycle. A pawl housing is directly coupled to a crank axle of the bicycle. The housing includes a plurality of pawls that are distributed about a perimeter of the housing. The pawls are extendible outward from the perimeter of the housing to engage the ratchet ring to rotate the sprocket when the crank axle is rotated by forward pedaling. A clutch disk includes a plurality of radial projections that are each configured to extend outward a pawl of the plurality of pawls when that pawl is rotated to that radial projection by forward rotation of the crank axle. The clutch disk is coupled to a friction element that resists rotation of the clutch disk relative to a chassis of the bicycle.

### FIELD OF THE INVENTION

The present invention relates to bicycles. More particularly, the present invention relates to a drive mechanism that enables a bicycle to coast.

### BACKGROUND OF THE INVENTION

Bicycle motocross (BMX) bicycles have become popular for performance of various stunts or tricks. Such tricks may involve coasting forward or backward.

For example, a trick may include jumping into the air from the ground, ramp or platform. During the jump, the bicycle may be flipped or rotated. At the conclusion of a jump, the bicycle may land while traveling in reverse. Other tricks may involve pedaling uphill on a slope and then coasting backward down the slope or reversing direction without lifting the rear wheel off the ground.

In a typical bicycle, the rear wheel of the bicycle may be propelled in a forward direction by pedaling. Motion of the pedals is transmitted to the rear wheel by a chain that links a chainwheel or sprocket that is rotated by the pedals to a cog or driver in the hub of the rear wheel. Coasting typically involves cessation of pedaling while the wheels of the bicycle continue to turn. For example, a simple ratchet mechanism may enable forward pedaling of the bicycle and coasting in a forward direction. In some cases (e.g., in some children's bicycles), a coaster brake may enable forward or backward coasting, but backward pedaling brakes the rear wheel.

### SUMMARY OF THE INVENTION

There is thus provided, in accordance with an embodiment of the present invention, a drive mechanism to enable a bicycle to coast forward or backward, the device including: a ratchet ring that is directly coupled to a sprocket of the bicycle; a pawl housing that is directly coupled to a crank axle of the bicycle, the housing including a plurality of pawls that are distributed about a perimeter of the housing, the pawls being extendible outward from the perimeter of the housing to engage the ratchet ring to rotate the sprocket when the crank axle is rotated by forward pedaling; and a clutch disk that includes a plurality of radial projections, each radial projection configured to extend outward of a pawl of the plurality of pawls when that pawl is rotated to that radial projection by forward rotation of the crank axle, the clutch disk being coupled to a friction element that resists rotation of the clutch disk relative to a chassis of the bicycle.

Furthermore, in accordance with an embodiment of the present invention, the pawl housing includes a retraction mechanism to retract a pawl of the plurality of pawls when not extended outward by a radial projection of the plurality of radial projections.

Furthermore, in accordance with an embodiment of the present invention, the retraction mechanism includes a mechanism that is selected from a group of mechanisms consisting of an elastic ring, a magnet and a spring.

Furthermore, in accordance with an embodiment of the present invention, the mechanism is configured such that the retraction mechanism retracts that pawl when no forward torque is applied to the crank axle.

Furthermore, in accordance with an embodiment of the present invention, the clutch disk is directly coupled to the friction element.

Furthermore, in accordance with an embodiment of the present invention, the clutch disk is coupled to the friction element via a planetary gear mechanism.

Furthermore, in accordance with an embodiment of the present invention, the clutch disk is directly coupled to a sun gear of the planetary gear mechanism, the friction element is directly coupled to a carrier disk of the planetary gear mechanism, and a ring gear of the planetary gear mechanism is directly coupled to the sprocket.

Furthermore, in accordance with an embodiment of the present invention, the planetary gear mechanism is configured to provide a predetermined slack angle.

Furthermore, in accordance with an embodiment of the present invention, the friction element includes a radial plunger.

Furthermore, in accordance with an embodiment of the present invention, the friction element includes an axial spring, magnet or plunger.

Furthermore, in accordance with an embodiment of the present invention, a pawl of the plurality of pawls is extendible by rotation about an axis.

Furthermore, in accordance with an embodiment of the present invention, a direction of rotation of the pawl relative to the pawl housing is selectable.

Furthermore, in accordance with an embodiment of the present invention, a face of a tooth of the ratchet ring forms an acute angle with a local tangent to the ratchet ring.

There is further provided, in accordance with an embodiment of the present invention, a drive mechanism to enable a bicycle to coast forward or backward, the mechanism including: a first cone and a second cone, one of the cones being a female cone and the other of the cones being a male cone, wherein the first cone is directly coupled to a sprocket of the bicycle and the second cone, having internal threading, is configured to travel along corresponding external threading on a crank axle of the bicycle, and includes a friction element that resists rotation of that cone relative to a chassis of the bicycle, the threading being oriented such that the second cone is caused to travel toward the first cone when a forward torque is applied to the crank axle by forward pedaling so as to cause the cones to engage so as to apply a forward torque to the sprocket.

Furthermore, in accordance with an embodiment of the present invention, the second cone is configured to disengage from the first cone during forward coasting when the sprocket is connected via a chain to a driver cog that is fixed to a wheel of the bicycle.

Furthermore, in accordance with an embodiment of the present invention, the first cone includes the female cone and the second cone includes the male cone.

There is further provided, in accordance with an embodiment of the present invention, a freecoaster hub device to enable a bicycle to coast forward or backward, the device including: a ratchet ring that is directly coupled to a hub body of a wheel of the bicycle; a pawl housing that is directly coupled to a driver cog of a wheel of the bicycle, the housing including a plurality of pawls that are distributed about a perimeter of the housing, the pawls being extendible outward from the perimeter of the housing to engage the ratchet ring to rotate the hub body when the driver cog is rotated forward; and a clutch disk that includes a plurality of radial projections, each radial projection configured to extend a pawl of the plurality of pawls when that pawl is rotated to that radial projection by forward rotation of the driver cog, the clutch disk being coupled by a planetary gear to a friction element that resists rotation of the clutch disk relative to a chassis of the bicycle.

Furthermore, in accordance with an embodiment of the present invention, the clutch disk is directly coupled to a sun gear of the planetary gear mechanism, the friction element is directly coupled to a carrier disk of the planetary gear mechanism, and a ring gear of the planetary gear mechanism is directly coupled to the hub body.

Furthermore, in accordance with an embodiment of the present invention, a gear ratio of the planetary gear mechanism is configured to provide a predetermined slack angle.

Furthermore, in accordance with an embodiment of the present invention, the friction element includes an axial plunger, a spring or a magnet.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1A schematically illustrates a bicycle that incorporates a bicycle coasting drive mechanism, in accordance with an embodiment of the present invention.

FIG. 1B schematically illustrates a crank set that incorporates a bicycle coasting drive mechanism, in accordance with an embodiment of the present invention.

FIG. 2A is a schematic cross section of a bicycle coasting drive mechanism with a ratchet mechanism and planetary gear mechanism, in accordance with an embodiment of the present invention.

FIG. 2B schematically illustrates an exploded view of components of the bicycle coasting drive mechanism shown in FIG. 2A.

FIG. 3A schematically illustrates a crank axle of the bicycle coasting drive mechanism shown in FIG. 2B with extended pawls.

FIG. 3B schematically illustrates a magnetic retraction mechanism of the crank angle shown in FIG. 3A.

FIG. 3C schematically illustrates a spring retraction mechanism that includes a spring.

FIG. 3D schematically illustrates a ratchet ring with tangentially symmetric ratcheted structure.

FIG. 3E schematically illustrates a ratchet ring with tangentially symmetric ratcheted structure having tooth faces that form an acute angle with the local tangent.

FIG. 3F schematically illustrates a ratchet ring with tangentially asymmetric ratcheted structure having tooth faces that form an acute angle with the local tangent.

FIG. 4A schematically illustrates a sectional view of a planetary gear assembly for extending the pawls shown in FIG. 3A.

FIG. 4B schematically illustrates a clutch disk of the assembly shown in FIG. 4A.

FIG. 4C schematically illustrates an axial spring friction element of the planetary gear assembly shown in FIG. 4A.

FIG. 4D schematically illustrates an axial magnetic friction element of the planetary gear assembly shown in FIG. 4A.

FIG. 5A is a schematic cross section of a bicycle coasting drive mechanism with a ratchet mechanism, in accordance with an embodiment of the present invention.

FIG. 5B is a schematic cutaway view of the bicycle coasting drive mechanism shown in FIG. 5A.

FIG. 6A is a schematic cross section of a bicycle coasting drive mechanism with a conic mechanism, in accordance with an embodiment of the present invention.

FIG. 6B is a schematic cutaway view of the bicycle coasting drive mechanism shown in FIG. 6A.

FIG. 7 schematically illustrates a partial cutaway view of a freecoaster hub with a planetary gear, in accordance with an embodiment of the present invention.

FIG. 8 schematically illustrates components of a planetary gear assembly of the freecoaster hub shown in FIG. 7.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

In accordance with an embodiment of the present invention, a bicycle coasting drive mechanism of a bicycle transmission (referred to herein as a coasting drive mechanism) may be configured to enable a bicycle or other pedal-driven vehicle to coast in a forward or backward direction. The bicycle coasting drive mechanism may be incorporated within a crankset of the bicycle that includes a crank axle that rotates together with the pedals. The bicycle coasting drive mechanism may enable the crank axle engage a sprocket of the bicycle when rotated in a forward direction by forward pedaling, and to disengage from the sprocket during coasting. Typically, the crank axle, the sprocket, and the major components of the coasting drive mechanism (as opposed to subcomponents), are arranged coaxially. For example, an interaction mechanism between the rotation of the crank axle and a stationary bottom bracket of the bicycle may engage the sprocket to the crank axle when the crank axle is pedaled in the forward direction. Thus, the sprocket may, via the bicycle chain, apply a torque to the rear wheel of the bicycle to propel the bicycle. When the bicycle is coasting, the rear wheel of the bicycle continues to rotate while the pedals, and thus the crank axle, remain approximately stationary. In this case, the interaction mechanism may disengage the sprocket from the crank axle such that the pedals may remain stationary as the rear wheel rotates in either a forward or backward direction.

Typically, the bicycle coasting drive mechanism may be configured such that a small amount of forward pedaling, e.g., up to a maximum angle of rotation, does not engage the sprocket. This maximum amount of pedaling is herein referred to as slack. The slack may be characterized by a slack angle that indicates an angle of rotation of the pedals before engaging the sprocket. A bicycle coasting drive mechanism that provides slack may enable a rider to involuntarily or voluntarily rotate the pedals by a small amount when coasting. Pedaling in excess of the slack may cause abrupt engaging of the sprocket. Abrupt engaging of the sprocket could stress the drive mechanisms and could cause an abrupt or unexpected acceleration of the bicycle. In accordance with some embodiments of the present invention, a bicycle coasting drive mechanism may include a planetary gear to increase the slack angle.

In some cases, the driver on the rear wheel may be fixed to the rear wheel. In this case, when coasting, the rotation of the rear wheel may be transmitted to the sprocket via the chain. Thus, the sprocket may continue to rotate when the bicycle is coasting. The bicycle coasting drive mechanism, in this case, may operate to disengage the pedals and crank axle from the sprocket during coasting. In some cases, the driver on the rear wheel may be connected to the rear wheel via a cassette or other mechanism that disengages the driver from the rear wheel during forward coasting (e.g., via a ratchet mechanism).

For example, the interaction mechanism of the bicycle coasting drive mechanism may include a disk with a plurality of radial projections and a ratchet-like mechanism (referred to hereinafter as a “ratchet mechanism”). The disk, herein referred to as a clutch disk, may be coupled, either directly, or indirectly via a planetary gear mechanism, to a component that exerts a force to resist rotation relative to a stationary (e.g., non-rotatable) component of the bicycle frame or chassis. Herein, the component is referred to as a friction element and the motion resistant force is referred to as friction, whether force is generated by mechanical friction or otherwise (e.g., by magnetism or electromagnetic forces). For example, the stationary component may include a bottom bracket inside which a crank mechanism of the bicycle is mounted. As used herein, direct coupling between two components refers to coupling that constrains the coupled components to rotate together. Indirect coupling refers to a coupling that enables at least limited relative rotation between the coupled components. The (static) friction force that is exerted by the friction element may be configured to be sufficient to enable the crank axle to initially engage the sprocket during forward pedaling. The (kinetic) friction force may be sufficiently small so as to enable the friction element to rotate relative to other components of the coasting drive mechanism after the crank axle engages the sprocket.

A pawl housing of the ratchet mechanism, having a plurality of extendible pawls distributed about its perimeter, is directly coupled to the crank axle (which is directly coupled to the pedals). (As used herein, direct coupling refers to elements that are constrained to rotate together with a single rotational velocity.) A retraction mechanism (e.g., including a resilient component or a magnet) maintains the pawls in a retracted state. When the pawl housing is rotated in a forward direction by forward pedaling, each of the pawls is rotated toward one of the radial projections of the clutch disk (which is held approximately stationary by the friction elements, as well as by inertia of the sprocket and coupled structure). Contact with the radial projections may extend each pawl outward from the perimeter of the pawl housing.

The extended pawls may engage internal corresponding ratchet grooves on a ring that is directly coupled to the sprocket. Thus, when the crank axle is rotated by forward pedaling, the extended pawls rotate the sprocket and, thus, the rear wheel. During coasting, the pawls may be retracted (e.g., by a spring, elastic ring or band, magnet or other retraction mechanism). In some cases, the clutch disk may couple to the friction elements via a planetary gear mechanism. The gear ratio of the planetary gear mechanism may operate to increase the angle through which the crank axle must be rotated before extending the pawls. Thus, the planetary gear may operate to increase the slack of the bicycle coasting drive mechanism relative to mechanisms without a planetary gear. The maximum slack angle may be attained during backward coasting.

As another example, the interaction mechanism of the bicycle coasting drive mechanism may extend a male cone with internal threading that cooperates with external threading on the crank axle. The male insert includes friction elements that resist rotation relative to the bicycle chassis. When the crank axle is rotated by forward pedaling, the male cone may, due to the friction, travel along the threading and into a correspondingly shaped female cone that is connected to the sprocket. Friction between the outer surface of the male cone and the inner surface of the female cone may then rotate the sprocket together with the crank axle. During coasting, the male cone may be withdrawn from the female cone, e.g., by action of a fixed coupling of the driver cog to the rear wheel that causes the sprocket to rotate in a manner that causes the male insert to travel along the threading away from the female cone.

In some cases, a planetary gear may be added to a rear wheel freecoaster hub to increase the slack angle of the freecoaster hub relative to hub that lacks a planetary gear. Maximum slack angle may be attained during backward coasting.

A bicycle coasting drive mechanism, in accordance with an embodiment of the present invention, is described herein as incorporated into a bicycle whose rear wheel is driven by pedals via a chain. However, the bicycle coasting drive mechanism may be incorporated into other types of pedal-driven vehicles whose pedal axis is displaced from the axis of the driven wheel. For example, the bicycle coasting drive mechanism may be incorporated into a unicycle, a pedal-driven cart or other vehicle with more than two wheels. A wheel that is driven by the pedals may include, in addition to or instead of a rear wheel, a front wheel or another wheel. For example, the pedal mechanism may drive an axle to which two wheels are fixed. A transmission for enabling pedal motion to drive a wheel of the vehicle may include a chain or other component (e.g., a drive shaft) that is capable or transmitting rotational motion from a pedal to a laterally displaced drive wheel. Any references herein to bicycle, rear wheel or chain, unless indicated otherwise, should be understood as including other types of vehicles, drive wheels, or transmissions, respectively.

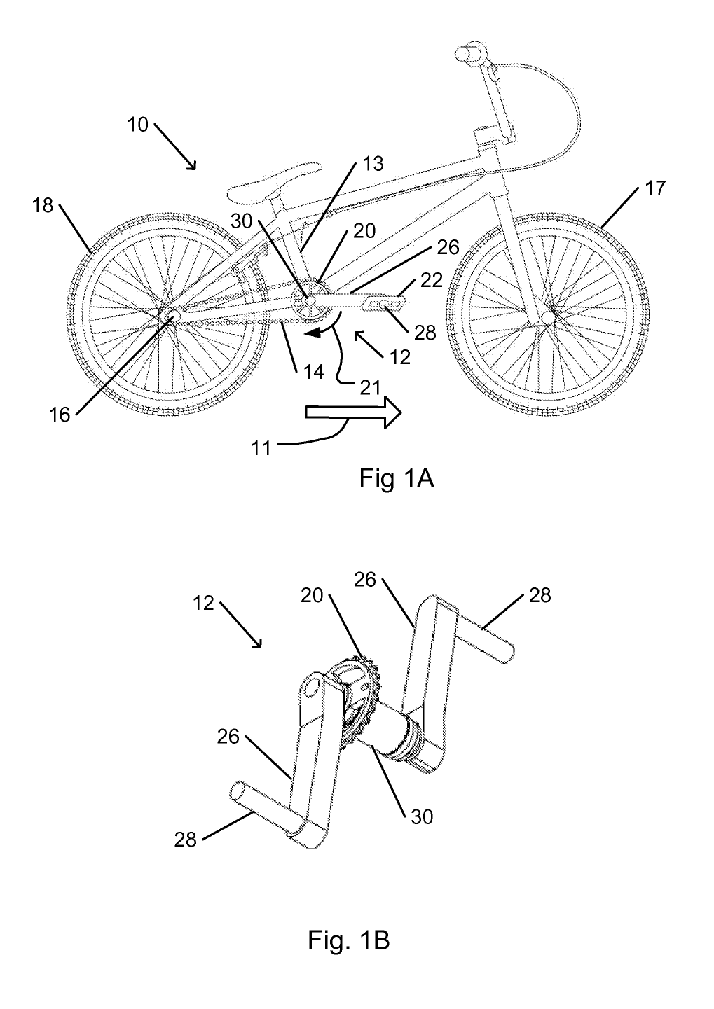

FIG. 1A schematically illustrates a bicycle that incorporates a bicycle coasting drive mechanism, in accordance with an embodiment of the present invention. FIG. 1B schematically illustrates a crank set that incorporates a bicycle coasting drive mechanism, in accordance with an embodiment of the present invention.

Bicycle 10 may represent a BMX bicycle or another type of bicycle or pedal-driven vehicle. Bicycle 10 may be propelled in forward bicycle direction 11 by pedaling on pedals 22 in forward rotation direction 21. Each pedal 22 is connected to a crank arm 26 via pedal spindle 28.

Pedaling on pedals 22 applies a torque to crank arms 26. Pedaling on pedals 22 in forward rotation direction 21 operates bicycle coasting drive mechanism 30 to engage sprocket 20. Engaging sprocket 20 may cause sprocket 20 to likewise rotate in forward rotation direction 21. The torque that is applied to pedals 22 is transmitted by bicycle coasting drive mechanism 30 to sprocket 20. Bicycle coasting drive mechanism 30 may be mounted within a bottom bracket of bicycle chassis 13.

When sprocket 20 rotates in forward rotation direction 21, chain 14 is pulled to travel in forward rotation direction 21. Thus, chain 14, to be understood as representing any suitable transmission mechanism, may transmit the torque that is applied to pedals 22 to driver cog 16 of rear wheel 18. Rear wheel 18 may be understood to represent any drive wheel of a pedal-driven vehicle.

Driver cog 16 may be fixed to rear wheel 18, such that driver cog 16 and rear wheel 18 are directly coupled so as to rotate together. In this case, any rotation of rear wheel 18 may be transmitted by chain 14 to sprocket 20. In this case, a rotation of rear wheel 18 in any direction causes sprocket 20 to rotate in the same direction.

Alternatively, driver cog 16 may connect to rear wheel 18 via a cassette or other ratcheted mechanism. The ratcheted mechanism may be configured to enable uncoupled separate rotation of driver cog 16 and rear wheel 18 under at least some circumstances. For example, a torque that is applied to driver cog 16 in forward rotation direction 21 may engage the ratchet mechanism and apply a forward torque to, and angularly accelerate, rear wheel 18. During coasting, on the other hand, when no torque is applied to driver cog 16 (e.g., due to cessation of pedaling), the ratchet mechanism may enable rear wheel 18 in forward rotation direction 21 relative to stationary, or more slowly rotating, driver cog 16.

During coasting, no torque is applied to pedals 22. However, rear wheel 18 may rotate in either in forward rotation direction 21 or in an opposite, backward rotation direction. The direction of rotation of rear wheel 18 may depend on how bicycle 10 was maneuvered prior to coasting (e.g., during the course of a jump), on a current orientation of bicycle 10 (e.g., when coasting downhill after pedaling uphill), or on other factors. Depending on how driver cog 16 is coupled to rear wheel 18, driver cog 16 and sprocket 20 may or may not rotate during coasting. Bicycle coasting drive mechanism 30 may be configured such that, during coasting, motion of pedals 22 is disengaged from motion of sprocket 20. Thus, sprocket 20 may rotate independently of rotation of pedals 22 (and of crank arms 26).

During coasting, a rider may rotate pedals 22 by a small amount. For example, the pedaling may result from unintended leg movements during the performance of tricks, to increase rider comfort, or from other causes. Bicycle coasting drive mechanism 30 may be configured such that a small rotation of pedals 22 in forward rotation direction 21, e.g., through less than a threshold rotation angle, does not engage sprocket 20. This freedom to forward pedal without engaging sprocket 20 is referred to herein as slack of, or provided or enabled by, bicycle coasting drive mechanism 30.

Bicycle coasting drive mechanism 30 may be further configured such that, during rotation of pedals 22 in a backward rotation direction (opposite to forward rotation direction 21), pedals 22 are disengaged from sprocket 20.

A pedal-driven vehicle may include one or more additional wheels, such as front wheel 17 of bicycle 10. The additional wheels may be configured to rotate freely, without being driven by rotation of pedals 22. The additional wheels may provide increased stability of the pedal-driven vehicle, steering or braking capability, or other functionality.

In accordance with an embodiment of the present invention, a bicycle coasting drive mechanism may include pawls that are extendible to engage sprocket 20 when pedals 22 are pedaled in forward rotation direction 21. During forward or backward coasting, the pawls may be retracted to disengage pedals 22 from sprocket 20. The bicycle coasting drive mechanism 30 may include a planetary gear that increases the slack of the bicycle coasting drive mechanism relative to a coasting drive mechanism that lacks a planetary gear. The maximum slack angle may be attained during backward coasting.

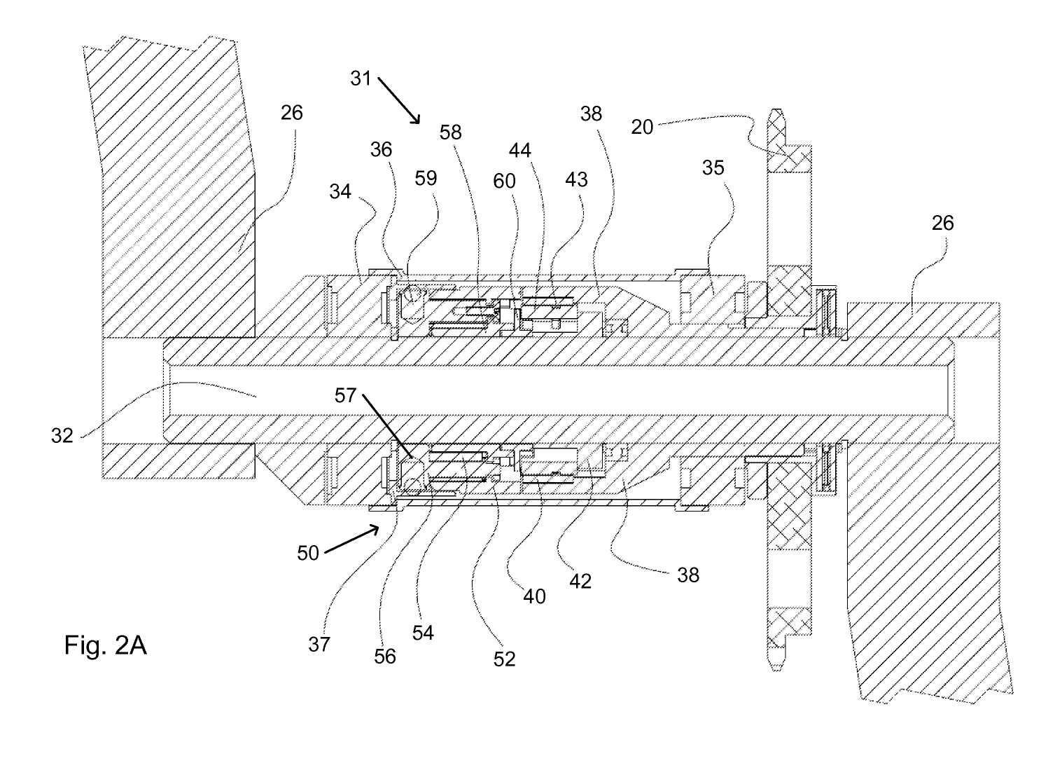

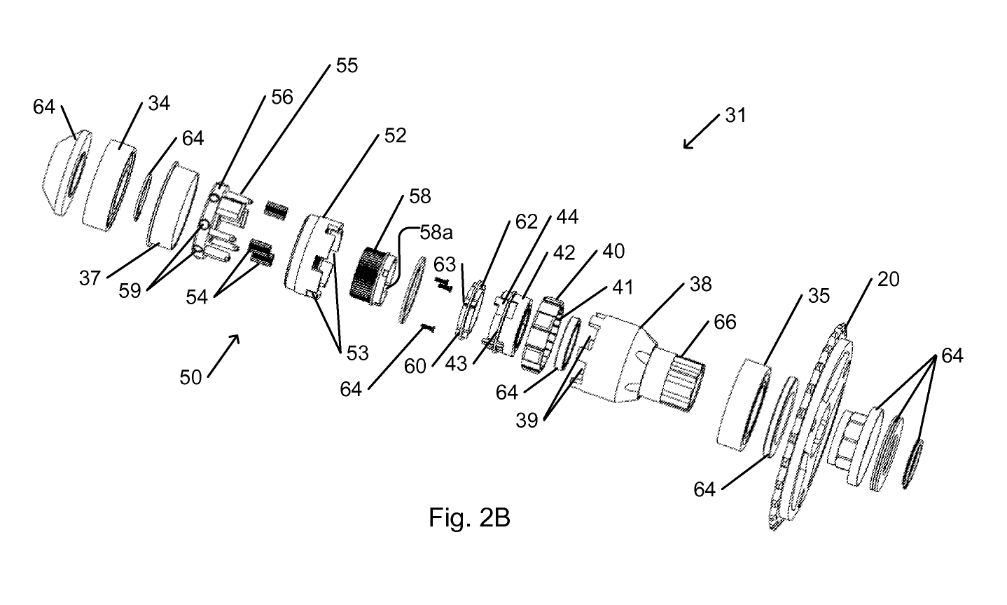

FIG. 2A is a schematic cross section of a bicycle coasting drive mechanism with a ratchet mechanism and planetary gear mechanism, in accordance with an embodiment of the present invention. FIG. 2B schematically illustrates an exploded view of components of the bicycle coasting drive mechanism shown in FIG. 2A.

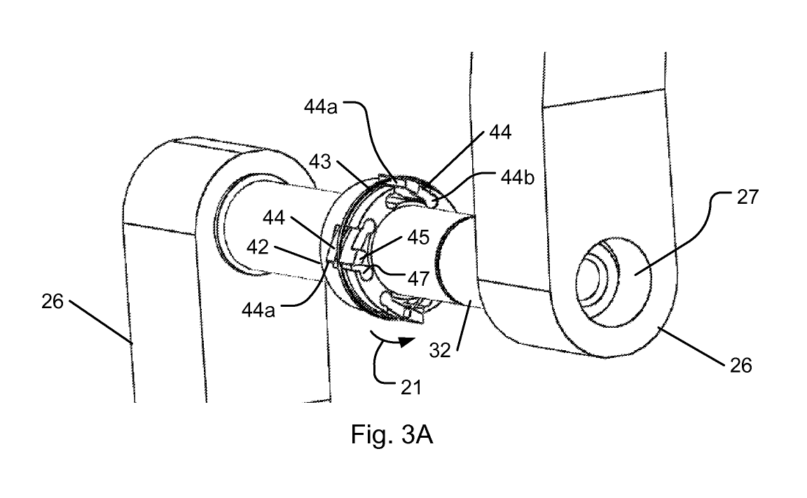

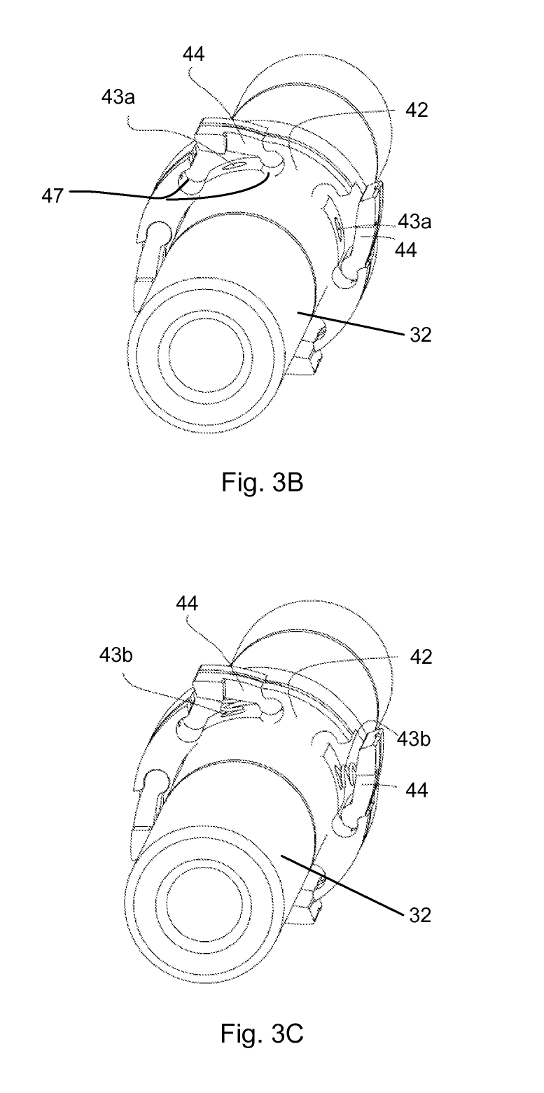

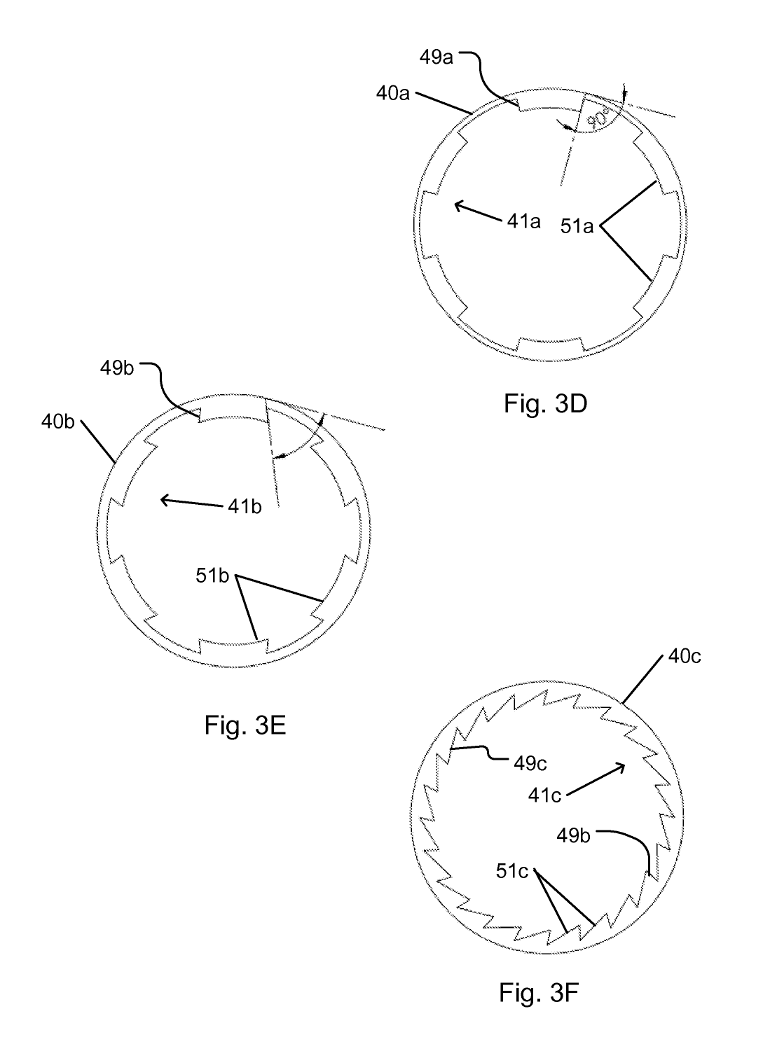

Ratcheted coasting drive mechanism 31 is mounted within bottom bracket 36, which is fixed to, or incorporated into, bicycle chassis 13 (FIG. 1A). Crank arms 26 are directly coupled to crank axle 32. Ends of crank axle 32 may be configured with structure (e.g., with grooves and ridges) to engage corresponding structure within a socket 27 (shown in FIG. 3) of each crank arm 26. The structure may prevent relative rotation between crank arms 26 and crank axle 32.

Bearing 34 may enable crank axle 32 to rotate relative to bottom bracket 36. Mechanical components 64 may enable assembling components of ratcheted coasting drive mechanism 31 into a single unit and maintaining ratcheted coasting drive mechanism 31 as a single unit. For example, mechanical components 64 may include one or more caps, spacers, retaining rings, nuts, bearings, screws, pins or other structure to enable maintaining the assembly and proper operation of ratcheted coasting drive mechanism 31.

Pawl housing 42 is directly coupled to crank axle 32 such that pawl housing 42 rotates with crank axle 32 and, thus, with crank arms 26 and pedals 22. Pawl housing 42 includes one or more pawls 44 that are extendible by interaction of structure of pawls 44 with radial projections 62 on clutch disk 60. Pawls 44 are distributed about the perimeter of pawl housing 42. Typically, pawls 44 may be distributed in a uniform manner about the perimeter of pawl housing 42. Thus, the positions of pawls 44 about a central axis of pawl housing 42 may be separated by equal angles.

Retraction structure 43 is configured to maintain pawls 44 in a normally retracted state unless extended outward by interaction with radial projections 62. For example, retraction structure 43 may include an elastic or resilient ring or band that surrounds pawls 44, as shown in FIG. 2B. Alternatively or in addition, retraction structure 43 may include one or more other mechanisms for maintaining pawls 44 in a retracted state. For example, each pawl 44 may be connected to a spring or other resilient element that applies a tension, pressure or torsion to maintain each pawl 44 in the retracted state. As another example, each pawl 44 may include a magnetic or electrostatic mechanism between structure on pawl 44 (e.g., magnet, magnetic material, dielectric material or other structure) and corresponding structure (e.g., magnetic material, magnet, electrostatic generator or other structure) on pawl housing 42 to pull each pawl 44 inward in a retracted state. Other retraction mechanisms may be used.

Sprocket 20 is directly coupled to cup structure 38 such that cup structure 38 rotates together with sprocket 20. For example, cup structure 38 may include end structure 66 that is configured to engage corresponding structure of sprocket 20. Bearing 35 may enable cup structure 38 to rotate relative to bottom bracket 36. Ratchet ring 40, which includes ratcheted structure 41, is inserted into and directly coupled to cup structure 38, so that ratchet ring 40 rotates together with cup structure 38 (and with sprocket 20). Alternatively, ratchet ring 40 may be integral to (e.g., produced as a single piece with) cup structure 38. A removable ratchet ring 40 may enable reversing the direction of ratchet ring 40 relative to cup structure 38. For example, ratchet ring 40 may be reversed in order to reconfigure ratcheted coasting drive mechanism 31 for right or left placement of sprocket 20. Alternatively or in addition, reversibility may be achieved by configuring ratcheted structure 41 with tangentially symmetric ratchet teeth.

FIG. 3A schematically illustrates a crank axle of the bicycle coasting drive mechanism shown in FIG. 2B with extended pawls.

Each pawl 44 may be extended outward. For example, each pawl 44 may be rotated about pawl axis 44b to extend leading edge 44a outward. Pawl axis 44b may be rounded to rotate within axis socket 47 of pawl housing 42. In the example shown, each pawl axis 44b may be inserted into one of two axis sockets 47. Provision of two axis sockets 47 may enable selection of an orientation of each pawl (e.g., a direction of rotation about pawl axis 44b) relative to pawl housing 42, e.g., when adapting ratcheted coasting drive mechanism 31 for right-left reversal of a side of bicycle 10 on which sprocket 20 (and chain 14) is placed. The pawls 44 may include one or more protrusions that are configured to engage with corresponding indentations of the ratchet ring. In this case, pawls 44 may be configured to extend radially outward (e.g., without rotation about an axis), and to be retracted radially inward.

Ratchet ring 40 includes ratcheted structure 41 on its inner surface. Ratcheted structure 41 is configured to be engaged by leading edge 44a of each extended pawl 44 when pawls 44 are rotated in forward rotation direction 21 relative to pawl housing 42. Thus, pawls 44 may extend outward to function as pawls with regard to ratcheted structure 41 of ratchet ring 40. Ratcheted structure 41 includes a plurality of ratchet teeth. The number of ratchet teeth, or, equivalently, the angular distance between adjacent ratchet teeth, may be configured to provide a desired or predetermined slack angle.

When leading edges 44a are extended outward, pawls 44 slope outward and toward forward rotation direction 21. Thus, when pawls 44 extend outward, leading edge 44a of each pawl 44 may engage ratcheted structure 41 of ratchet ring 40 when crank axle 32 is rotated in forward rotation direction 21. When a forward torque is applied to crank axle 32 during forward pedaling, a normal force is applied to meeting of each leading edge 44a and ratcheted structure 41. The resulting friction may be sufficient to overcome the retraction force exerted by retraction structure 43. During coasting, however, the torque and normal force are no longer applied, enabling retraction structure 43 to retract pawls 44. In the case that driver cog 16 is fixed to rear wheel 18, sprocket 20 and ratcheted structure 41 continue to rotate in forward rotation direction 21. The ratchet teeth of ratcheted structure 41 may depress pawls 44 and cause radial projections 62 (described below) to rotate away from pawls 44.

Since pawl housing 42 is directly coupled to crank axle 32 and to pedals 22, extending pawls 44 outward and rotating in forward rotation direction 21 may engage pedals 22 to cup structure 38, and thus to sprocket 20. Thus, when pawls 44 are extended, pedaling on pedals 22 to turn crank axle 32 in forward rotation direction 21 may drive sprocket 20 and rear wheel 18. On the other hand, if pedaling ceases or is reversed (pedaling in a backward direction) as rear wheel 18 continues to roll in forward rotation direction 21, pawls 44 may glide across ratcheted structure 41 of ratchet ring 40 without engaging ratcheted structure 41.

As shown, retraction structure 43 includes an elastic ring or band (e.g., made of elastic plastic, rubber, metal, cloth, or another material). Alternatively or in addition, retraction structure 43 may be otherwise configured. For example, retraction structure 43 may operate magnetically or by separate springs that act on each pawl 44.

FIG. 3B schematically illustrates a magnetic retraction mechanism of the crank angle shown in FIG. 3A.

In the example shown, retraction magnet 43a is placed on pawl housing 42. Retraction magnet 43a may attract a ferromagnetic material that is incorporated into pawl 44 to retract pawl 44. Alternatively or in addition, pawl 44 may include a magnet that is configured to attract a ferromagnetic component of pawl housing 42.

FIG. 3C schematically illustrates a spring retraction mechanism that includes a spring.

Extension of pawl 44 flexes (e.g., stretches or twists) retraction spring 43b. Retraction spring 43b may represent any resilient mechanical structure that tends to pull or rotate pawl 44 back toward pawl housing 42. For example, retraction spring 43b may represent a torsion spring that operates on tooth axis 44b to rotate pawl 44 about pawl axis 44b back toward pawl housing 42.

Ratchet ring 40 and ratcheted structure 41 may be asymmetric, as in a typical ratchet, or may be tangentially symmetric. For example, tangentially symmetric ratcheted structure may enable use of a single ratchet ring 40 whether sprocket 20 is placed on the left or the right of the bicycle. For example, tangentially symmetric ratcheted structure may enable incorporation left-right reversibility of ratcheted coasting drive mechanism 31 when ratchet ring 40 is incorporated into (e.g., produced as a single piece with) cup structure 38

FIG. 3D schematically illustrates a ratchet ring with tangentially symmetric ratcheted structure.

Ratchet ring 40a includes tangentially symmetric ratcheted structure 41a. Tangentially symmetric ratcheted structure 41a includes a plurality of symmetric ratchet teeth 51a. Each symmetric ratchet tooth 51a includes two tooth faces 49a. A tooth face 49a is configured to be engaged by a leading edge 44a of pawl 44 when leading edge 44a is extended outward. In the example shown, each tooth face 49a is substantially radial, or equivalently, for a substantial right angle (90°) with a local tangent to the perimeter of ratchet ring 40. In this case, each pawl 44 may be immediately retracted when a normal force that holds leading edge 44a to tooth face 49a is relaxed (e.g., by cessation of pedaling).

FIG. 3E schematically illustrates a ratchet ring with tangentially symmetric ratcheted structure having tooth faces that form an acute angle with the local tangent.

Ratchet ring 40b includes tangentially symmetric ratcheted structure 41b. Tangentially symmetric ratcheted structure 41b includes a plurality of symmetric ratchet teeth 51b. Each symmetric ratchet tooth 51b includes two tooth faces 49b. A tooth face 49b is configured to be engaged by a leading edge 44a of pawl 44 when leading edge 44a is extended outward. In the example shown, each tooth face 49b forms an acute angle (<90°, e.g., 70° or another acute angle) with a local tangent to the perimeter of ratchet ring 40. Thus, each tooth face 49b may form a groove into which leading edge 44a may be inserted when engaging ratcheted structure 41b.

FIG. 3F schematically illustrates a ratchet ring with tangentially asymmetric ratcheted structure having tooth faces that form an acute angle with the local tangent.

Ratchet ring 40c includes tangentially asymmetric ratcheted structure 41c. Tangentially asymmetric ratcheted structure 41c includes a plurality of asymmetric ratchet teeth 51c. Each asymmetric ratchet tooth 51b includes a tooth face 49b that is configured to be engaged by a leading edge 44a of pawl 44 when leading edge 44a is extended outward. In the example shown, each tooth face 49b forms an acute angle (<90°, e.g., 70° or another acute angle) with a local tangent to the perimeter of ratchet ring 40. Thus, each tooth face 49b may form a groove into which leading edge 44a may be inserted when engaging ratcheted structure 41b. Rear tooth face 49c may form a large obtuse angle with the local tangent that cannot be engaged by pawl 44.

As another example, a symmetric or asymmetric ratcheted structure may include tooth faces that form a mildly obtuse angle (e.g., ≦110°, or similar angles with the local tangent.

A mechanism for extending pawls 44 from pawl housing 42 operates via planetary gear 50.

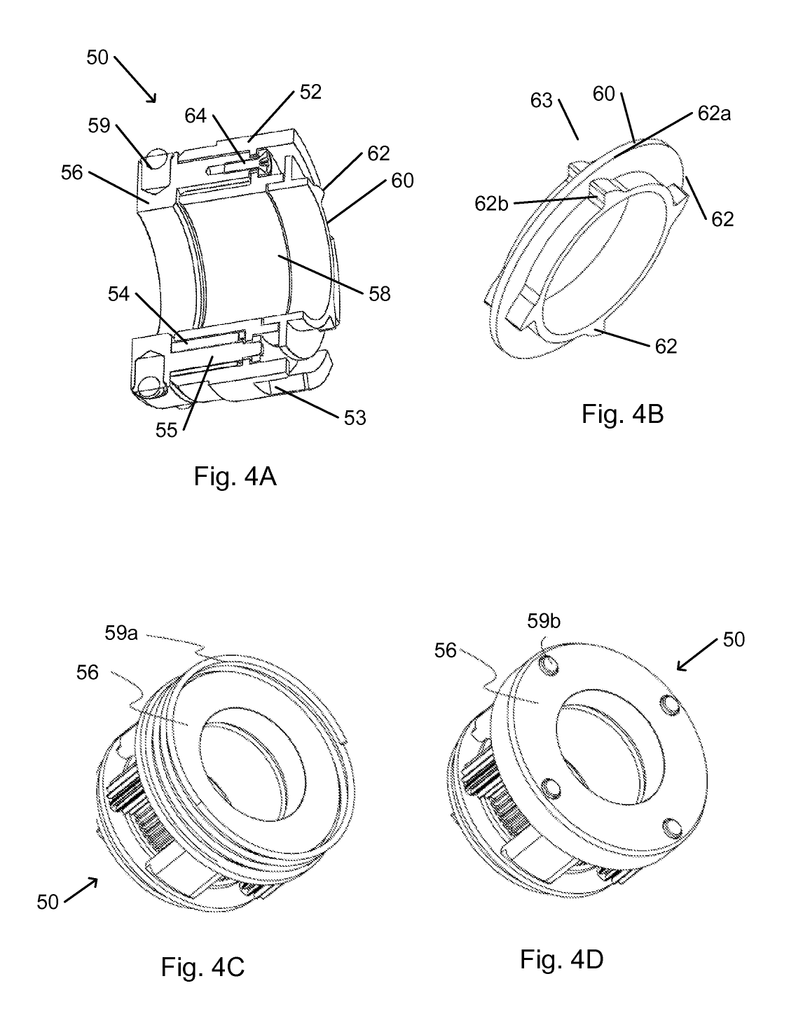

FIG. 4A schematically illustrates a sectional view of a planetary gear assembly for extending the pawls shown in FIG. 3A. FIG. 4B schematically illustrates a clutch disk of the assembly shown in FIG. 4A.

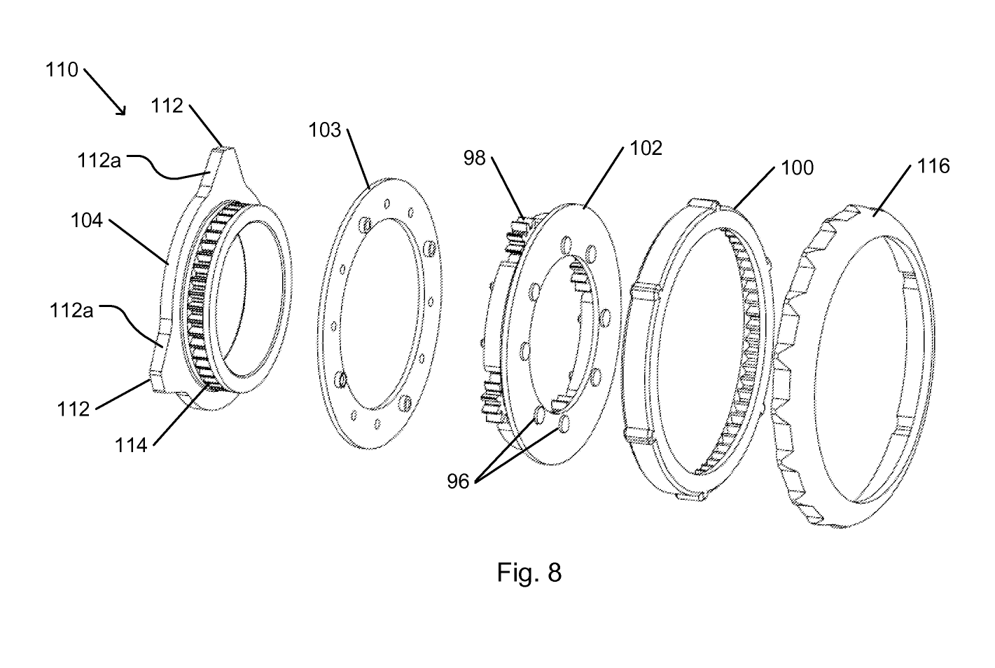

Radial projections 62 of clutch disk 60 may be rotated to extend pawls 44 from pawl housing 42. For example, when each radial projection 62 is rotated to the position of a pawl tab 45 of a pawl 44, pawl tab 45 may be pushed outward along ramp side 62a of each radial projection 62. The outward pushing of pawl tab 45 may push leading edge 44a of each pawl 44 outward. When radial projection 62 is rotated away from pawl tab 45, retraction structure 43 may retract leading edge 44a inward toward pawl housing 42. Alternatively or in addition, radial projection 62 may be configured to push against other structure of pawl 44. For example, a pawl 44 may be configured without a tab. When pawls 44 do not include tabs, each radial projection 62 may be tangentially symmetric (e.g., with both sides shaped similar to ramp side 62a, e.g., similar to radial projections 112 in FIG. 8),

In some cases, radial projections on clutch disk 60 may be symmetric (e.g., each projection having two ramp sides such that rear side 62b is also ramped). Typically, radial projection 62 are distributed about a central axis of clutch disk 60 with substantially equal separation angles that are also substantially equal to the separation angles between pawls 44 about pawl housing 42. The separation angles, together with other factors (e.g., angular separation between ratchet teeth of ratcheted structure 41, gear ratio of planetary gear 50, or other factors), may determine the maximum slack angle.

Clutch disk 60 may include additional radial projections 63 on a rear side of clutch disk 60. For example, clutch disk 60 may have a mirror symmetric structure to enable reversal (e.g., to accommodate a rider who prefers placement of sprocket 20 on a particular side of bicycle 10).

Clutch disk 60 is directly coupled to sun gear 58 of planetary gear 50. For example, additional radial projections 63 of clutch disk 60 may each insert into a tab slot 58a of sun gear 58 to cause sun gear 58 and clutch disk 60 to rotate together. Other coupling structure may be used. Alternatively or in addition, the direct coupling of clutch disk 60 to sun gear 58 may be achieved by producing (e.g., molding, printing, machining, or otherwise producing) clutch disk 60 and sun gear 58 as a single inseparable unit.

Cup structure 38 is directly coupled to ring gear 52 of planetary gear 50. For example, cup structure 38 may include finger extensions 39 that are configured to insert into corresponding finger slots 53 on ring gear 52. Other coupling structure may be used. Thus, ring gear 52 rotates together with cup structure 38 and with sprocket 20.

Each planet gear 54 of planetary gear 50 is mounted on a gear arm 55 of carrier disk 56. Carrier disk 56 includes structure that interacts via friction with bottom bracket 36, or other structure that is stationary with respect to bicycle chassis 13. For example, carrier disk 56 may include one or more friction elements 59 that exert a normal force, or other resistant force, on a surface of bottom bracket 36 or bicycle chassis 13. Friction elements 59 may include one or more spring-loaded plungers, as shown, that are pushed outward by resilient structure to contact and exert a normal force on a stationary surface. Alternatively or in addition, friction elements 59 may include magnets, pads, or other elements that may exert a force that resists rotation of carrier disk 56.

In the example shown, friction elements 59, in the form of radial plungers, may be inserted into plunger sockets 57 of carrier disk 56. Friction elements 59 may extend to contact an inner surface of bottom bracket 36. In some cases, a sleeve insert 37 may be inserted into bottom bracket 36. Sleeve insert 37 may include structure (e.g., a projection, indentation, or other mechanical structure that cooperates with corresponding structure of bottom bracket 36, friction-producing structure such as an 0-ring or spline, or other structure) to hold sleeve insert 37 stationary with respect to bottom bracket 36. Sleeve insert 37 may effectively adjust the inner diameter of bottom bracket 36 to enable adapting carrier disk 56 and friction elements 59 to contact the inner surface. Thus, bottom brackets 36 having a range of inner diameters may be adapted for operation with carrier disk 56 and ratcheted coasting drive mechanism 31.

Alternatively or in addition, friction elements 59 may otherwise apply friction between carrier disk 56 and bottom bracket 36. For example, a plunger or other element of carrier disk 56 (e.g., spring, or other element) may axially apply friction to structure (e.g., a flat annular ring) that is stationary with respect to bottom bracket 36. Friction elements 59 may include radial or axial magnets that may interact with ferromagnetic material in bottom bracket 36 or sleeve insert 37 (or other stationary structure) to resist rotation. Friction elements 59 may include a ring or disk of appropriate material (e.g., on the outer perimeter of carrier disk 56, or where the outer diameter of carrier disk 56 is approximately equal to an inner diameter of bottom bracket 36 or of sleeve insert 37) that is configured to slide along, and thus apply friction to, an inner surface of bottom bracket 36 or sleeve insert 37.

FIG. 4C schematically illustrates an axial spring friction element of the planetary gear assembly shown in FIG. 4A.

Axial spring friction element 59a may be configured to press against a surface of a component that is stationary with respect to bottom bracket 36 and that is perpendicular to the longitudinal axis of crank axle 32. For example, the surface may include a surface of bearing 34 that is stationary with respect to bottom bracket 36.

FIG. 4D schematically illustrates an axial magnetic friction element of the planetary gear assembly shown in FIG. 4A.

Axial magnetic friction element 59b may be configured to attract a surface (e.g., with a ferromagnetic component) of a component that is stationary with respect to bottom bracket 36 and that is perpendicular to the longitudinal axis of crank axle 32. For example, the surface may include a surface of bearing 34 that is stationary with respect to bottom bracket 36.

The friction between carrier disk 56 and bottom bracket 36, as well as friction between components of planetary gear 50 and inertial and other forces on sprocket 20 and coupled structure, may hold clutch disk 60 stationary when crank axle 32 does not engage sprocket 20.

For example, at the beginning of forward pedaling, crank axle 32 may be rotated in forward rotation direction 21 through the slack distance. Since clutch disk 60 is held stationary by friction and inertial and other forces on sprocket 20 and coupled structure, the rotation of crank axle 32 similarly rotates pawl housing 42 relative to clutch disk 60 until radial projections 62 extend pawls 44 outward. The rotation then causes extended pawls 44 to engage ratcheted structure 41 of ratchet ring 40. At this point, sprocket 20 and rear wheel 18 are rotated in forward rotation direction 21. Thus, pedaling in forward rotation direction 21 propels the bicycle forward. During forward pedaling, planetary gear 50 also rotates in forward rotation direction 21. During the rotation, the friction on carrier disk 56 applies a torque on sun gear 58 and clutch disk 60 in the backward direction. The torque in the backward direction maintains pressure of radial projections 62 on pawls 44 to maintain the extension of pawls 44 and the engagement of sprocket 20.

During forward coasting, after cessation of forward pedaling, rear wheel 18 continues to rotate in forward rotation direction 21, while crank axle 32 and pawl housing 42 no longer rotate. As a result, pawls 44 are no longer forced against ratcheted structure 41 such that retraction structure 43 retracts pawls 44 inward. In addition, a rider may instinctively pedal backward briefly when coasting, thus further removing the force of pawls 44 against ratcheted structure 41. Thus, crank axle 32 is disengaged from sprocket 20 and rear wheel 18.

When driver cog 16 of rear wheel 18 includes a cassette, rear wheel 18 may disengage during forward coasting from sprocket 20 such that sprocket 20 may no longer rotate. Friction forces, as well as inertial and other forces on sprocket 20 and coupled structure, may cause planetary gear 50 to stop rotating.

When driver cog 16 of rear wheel 18 is fixed to rear wheel 18, sprocket 20 may continue to rotate in a forward direction during forward coasting. Thus, ring gear 52 continues to rotate in forward rotation direction 21. However, friction forces on planetary gear 50 together with the continued forward rotation of sprocket 20, and thus of ratchet ring 40, cause crank axle 32 to disengage from sprocket 20.

During backward coasting, rear wheel 18 rolls backward while crank axle 32 does not rotate. The backward rotation of driver cog 16 (whether including a cassette or fixed) causes sprocket 20 to rotate backward. The resulting backward rotation of ratchet ring 40 disengages ratchet ring 40 from pawls 44. Pawls 44 may then be retracted by retraction structure 43. Thus, crank axle 32 is disengaged from sprocket 20. The backward rotation of sprocket 20 may rotate the directly coupled ring gear 52 and, via friction, the remainder of planetary gear 50, backward as well. As a result, clutch disk 60 may continue to rotate radial projections 62 away from pawls 44 until stopped by contact with pawl housing 42. For example, further backward rotation may be stopped by contact of rear end 62b of radial projection 62 with pawl tab 45 or pawl axis 44b of one of pawls 44.

The rotation of clutch disk 60 so as to rotate radial projections 62 away from pawls 44 may create slack. The slack may enable a rider to pedal forward through the slack angle without engaging sprocket 20 and rear wheel 18. In the absence of planetary gear 50, the slack angle would be determined by the angular separation between adjacent pawls 44 or radial projections 62 (by the smaller of the two when the angular separations for pawls 44 and radial projections 62 differ from one another), as well as by angular separation between ratchet teeth of ratcheted structure 41. In the presence of planetary gear 50, the slack angle may be increased by a gear ratio of planetary gear 50. Maximum slack may be attained during backward coasting.

In some cases, a gear ratio of planetary gear 50 may be selected so as to provide a predetermined slack angle. For example, diameters or numbers of cog teeth on one or more of ring gear 52, planet gears 54 and sun gear 58 may be configured to provide a predetermined or desired gear ratio.

Components of ratcheted coasting drive mechanism 31 may be assembled in reverse order from right to left. Thus, sprocket 20 may be placed near either the right or left end of crank axle 32 (e.g., to accommodate a rider with a preference for placement of sprocket 20 one either the right or left side). In reassembling in reverse order, some individual components may require reversal. For example, ratchet ring 40 may be reversed within cup structure 38 to reverse the direction of ratcheted structure 41. Alternatively, ratchet ring 40 may be integral to (e.g., produced as a single piece with) cup structure 38, where, the ratchet teeth in ratcheted structure 41 may be tangentially symmetric so as to operate in both directions. The direction of each pawl 44 on pawl housing 42 may be reversed. Clutch disk 60 may be reversed to interchange the function of radial projections 62 with that of additional radial projections 63.

In accordance with an embodiment of the present invention, a ratcheted coasting drive mechanism may operate without a planetary gear. Some of the function of a planetary gear assembly may be provided by a single friction disk that is directly coupled to the clutch disk.

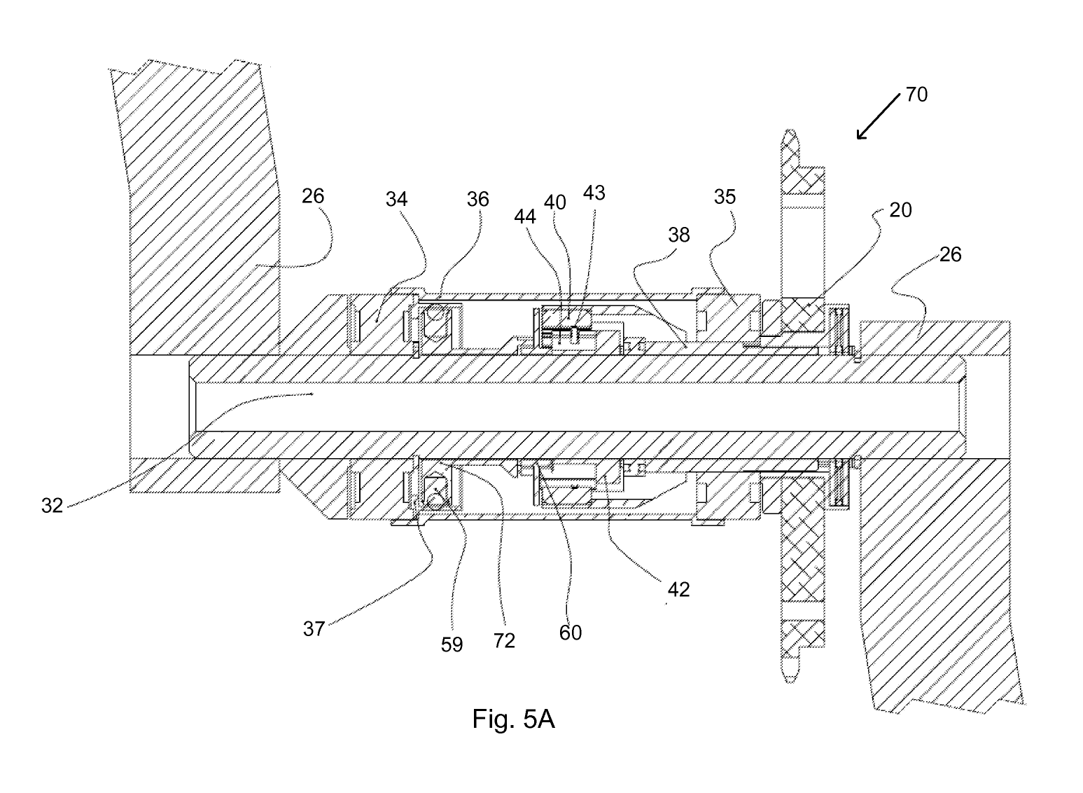

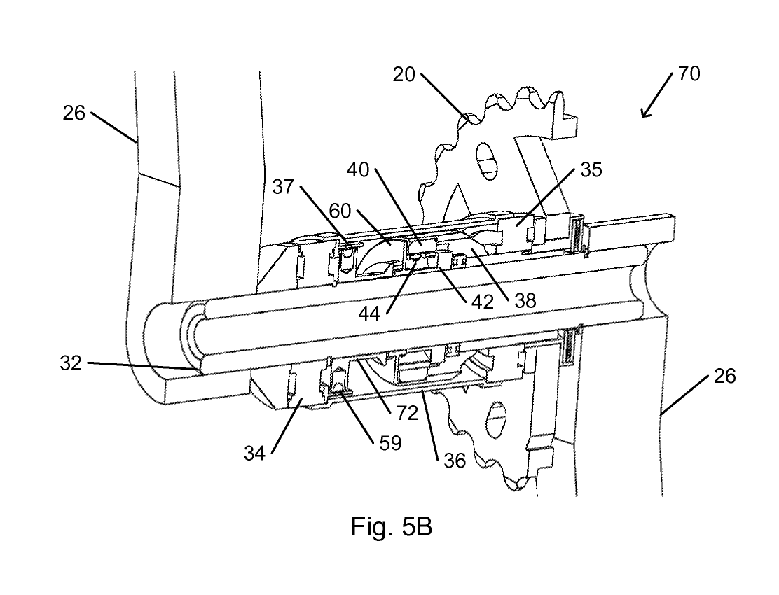

FIG. 5A is a schematic cross section of a bicycle coasting drive mechanism with a ratchet mechanism, in accordance with an embodiment of the present invention. FIG. 5B is a schematic cutaway view of the bicycle coasting drive mechanism shown in FIG. 5A.

Ratcheted coasting drive mechanism 70 includes friction disk 72. Clutch disk 60 is directly coupled to friction disk 72 such that clutch disk 60 rotates together with friction disk 72.

Friction disk 72 includes friction elements 59 that interact via friction with bottom bracket 36, or other structure that is stationary with respect to bicycle chassis 13. For example, friction elements 59 may include one or more friction elements that may extend outward to exert a normal force on a surface of bottom bracket 36 or bicycle chassis 13. The projections may include one or more spring-loaded plungers that are pushed outward by resilient structure to contact and exert a normal force on a stationary surface. For example, friction elements 59 may extend to contact an inner surface of bottom bracket 36 or of sleeve insert 37.

Alternatively or in addition, friction elements 59 may be configured to otherwise exert a friction force between friction disk 72 and bottom bracket 36. For example, a plunger or other element (e.g., a spring or other element) of friction disk 72 may axially apply friction to structure (e.g., a flat annular ring) that is stationary with respect to bottom bracket 36. Friction elements 59 may include magnets that may interact with ferromagnetic material in bottom bracket 36 or sleeve insert 37 (or other stationary structure) to resist rotation. Friction elements 59 may include ferromagnetic material to interact with magnets in bottom bracket 36 or sleeve insert 37 (or in both or in other stationary structure) to resist rotation. Friction elements 59 may include a ring or disk of appropriate material to slide along, and thus apply friction to, an inner surface of bottom bracket 36 or sleeve insert 37.

The friction between friction disk 72 and bottom bracket 36 may hold clutch disk 60 stationary when crank axle 32 does not engage sprocket 20.

For example, at the beginning of forward pedaling, crank axle 32 may be rotated in forward rotation direction 21 through the slack angle. Since clutch disk 60 is initially held stationary by friction on friction disk 72, the rotation of crank axle 32 similarly rotates pawl housing 42 relative to clutch disk 60 until radial projections 62 extend pawls 44 outward. The rotation then causes extended pawls 44 to engage ratchet ring 40. At this point, sprocket 20 and rear wheel 18 are rotated with forward rotation direction 21. Thus, pedaling in forward rotation direction 21 propels the bicycle forward. During the rotation, the friction on friction disk 72 applies a torque to clutch disk 60 in the backward direction. The torque in the backward direction maintains pressure of radial projections 62 on pawls 44, as well as the normal force of pawls 44 on ratcheted structure 41, to maintain the extension of pawls 44 and the engagement of sprocket 20.

During forward coasting, after cessation of forward pedaling, rear wheel 18 continues to rotate in forward rotation direction 21, while crank axle 32 and pawl housing 42 no longer rotate. As a result of the resulting removal of the normal force of pawls 44 on ratcheted structure 41, pawls 44 are no longer held to radial projections 62 and retraction structure 43 retracts pawls 44 inward. Thus, crank axle 32 is disengaged from sprocket 20 and rear wheel 18.

When driver cog 16 of rear wheel 18 includes a cassette, rear wheel 18 may disengage during forward coasting from sprocket 20 such that sprocket 20 may no longer rotate. The resulting removal of the normal force of pawls 44 on ratcheted structure 41 may enable retraction structure 43 to retract pawls 44. Thus, sprocket 20 is disengaged from crank axle 32.

When driver cog 16 of rear wheel 18 is fixed to rear wheel 18, sprocket 20 may continue to rotate in a forward direction during forward coasting. Thus, cup structure 38 and ratchet ring 40 continue to rotate in forward rotation direction 21, enabling retraction structure 43 to retract pawls 44 to disengage crank axle 32 from sprocket 20.

During backward coasting, rear wheel 18 rolls backward while crank axle 32 does not rotate. The backward rotation of driver cog 16 (whether including a cassette or fixed) causes sprocket 20 to rotate backward. Pawls 44 may then be retracted by retraction structure 43. Thus, crank axle 32 is disengaged from sprocket 20.

In accordance with an embodiment of the present invention, a bicycle coasting drive mechanism may engage crank axle 32 with sprocket 20 by operation of a mechanism that includes a first cone that is directly coupled to sprocket 20 and a second cone that is configured to travel along crank axle 32. For example, the mechanism for moving the second cone toward the first cone may include a screw mechanism that operates together with friction force between the second cone and the bicycle chassis. The second cone is configured to travel toward the first cone when a forward torque caused by forward pedaling is applied to crank axle 32. One of the cones is a female cone, and the other cone is a male cone. The outer surface of the male cone is shaped so as to abut a correspondingly shaped inner surface of the female cone when the second cone has moved to contact the first cone. Friction between the abutting surfaces may then cause a torque that is applied to the second cone to be applied to the first cone and, thus, to sprocket 20, as well.

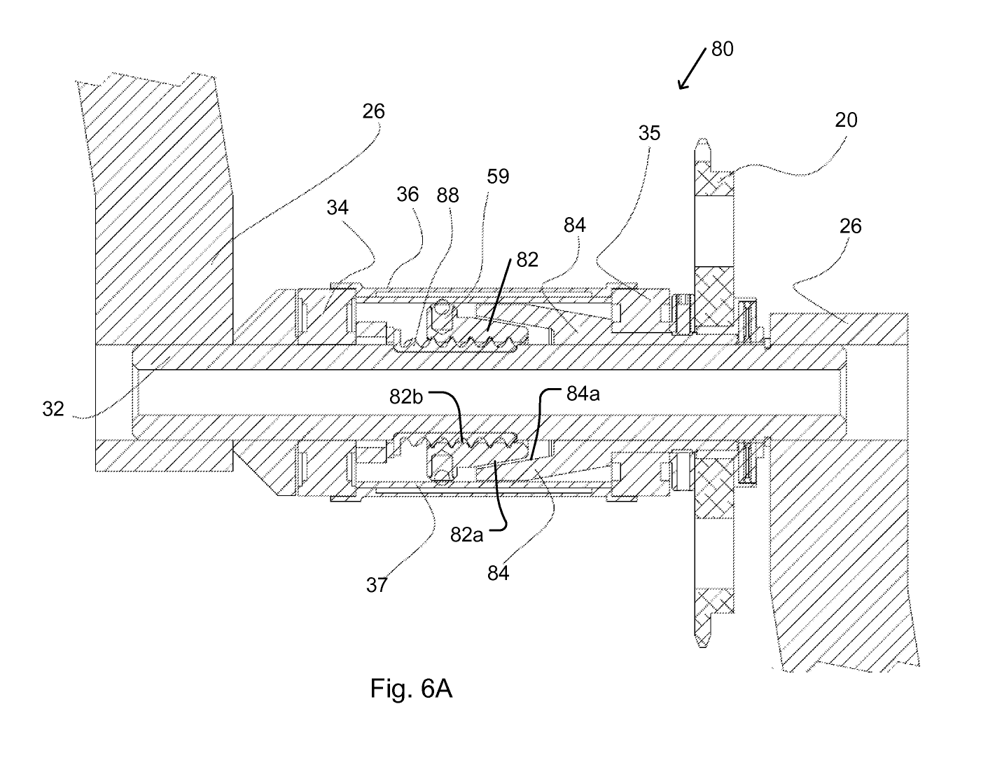

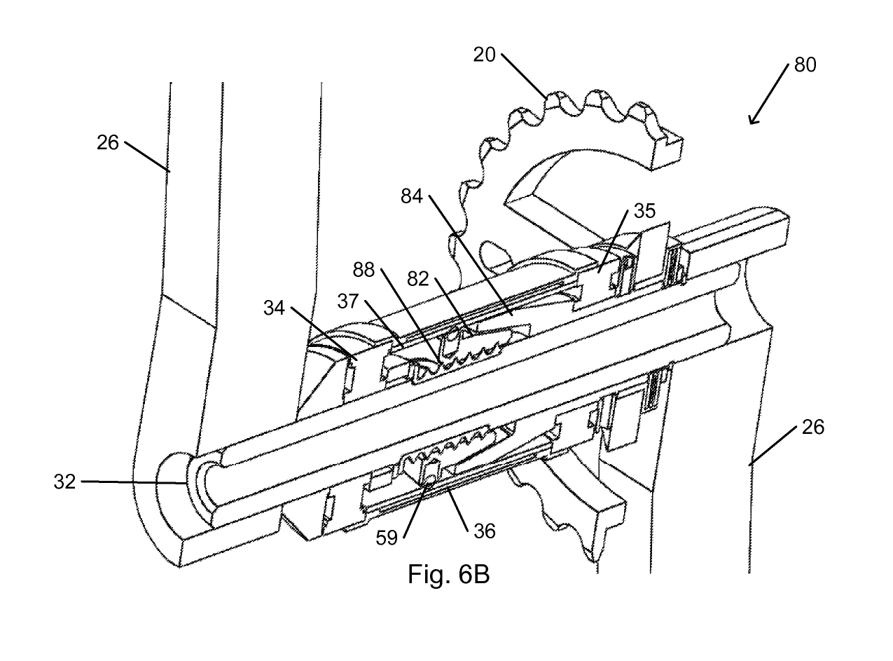

FIG. 6A is a schematic cross section of a bicycle coasting drive mechanism with a conic mechanism, in accordance with an embodiment of the present invention. FIG. 6B is a schematic cutaway view of the bicycle coasting drive mechanism shown in FIG. 6A.

Although the example illustrated in FIGS. 6A and 6B shows a female cone 84 directly coupled to sprocket 20 and a moveable male cone 82, a male cone may be coupled to sprocket 20, and a female cone may be moveable along crank axle 32 (e.g., with corresponding changes to the shapes of other components of the drive mechanism).

Cone drive mechanism 80 may operate to enable forward and backward coasting when driver cog 16 is fixed to rear wheel 18 so as to rotate together with rear wheel 18.

In cone drive mechanism 80, female cone 84 is directly coupled to sprocket 20 so as to rotate together. Male cone 82 is configured to move toward or away from female cone 84 along crank axle 32. When the outer surface 82a of male cone 82 is forced against inner surface 84a of female cone 84, sprocket 20 is directly coupled to crank axle 32. At other times, sprocket 20 may rotate substantially independently of crank axle 32.

Alternatively, a female cone may be configured to move toward or away from a male cone that is directly coupled to sprocket 20.

A mechanism for moving one cone toward or away from the other cone may include a screw mechanism. For example, a portion of the length of crank axle 32 may be provided with external threading 88. An interior surface of male cone 82 is provided with corresponding internal threading 82b. Male cone 82 is provided with friction elements 59 to resist rotation of male cone 82 relative to bottom bracket 36 or to sleeve insert 37. Friction elements 59 may include radial plungers, as shown, or may include other motion resistant structure as described above.

In some cases, external threading 88 may be provided in the form of a removable sleeve that may be coupled to crank axle 32. When the threading is removed, reversed and replaced, cone drive mechanism 80 may be reconfigured for right or left placement of sprocket 20.

When pedaling rotates crank axle 32 in forward rotation direction 21, the friction force that is exerted by friction elements 59, and the interaction of internal threading 82b with external threading 88, may cause male cone 82 to move toward female cone 84. When outer surface 82a of male cone 82 contacts inner surface 84a of female cone 84, the exerted force may cause female cone 84 and, thus, sprocket 20 to rotate together with male cone 82 and crank axle 32. Thus, with male cone 82 engaging female cone 84, the torque of the pedaling may applied to sprocket 20. Sprocket 20 may then, via chain 14 and driver cog 16, rotate rear wheel 18 in forward rotation direction 21, thus propelling bicycle 10 forward.

It may be noted that the maximum slack may be determined by a length of external threading 88, or by other elements that limit travel of male cone 82 away from female cone 84. The actual slack at any time may be determined by a current distance of male cone 82 from female cone 84.

When coasting forward, rear wheel 18 continues to roll in forward rotation direction 21 while crank axle 32 is held stationary. Since driver cog 16 is fixed to rear wheel 18, sprocket 20 and female cone 84 continue to rotate in forward rotation direction 21. The continued forward rotation of female cone 84 may initially pull male cone 82 forward in forward rotation direction 21 relative to stationary crank axle 32. Therefore, male cone 82 may travel on external threading 88 away from female cone 84, thus disengaging sprocket 20 from crank axle 32.

It may be noted that, during a jump, when rear wheel 18 is lifted off the ground after forward pedaling, rear wheel 18 may continue to rotate in forward rotation direction 21 due to its angular momentum. This continued rotation may affect cone drive mechanism 80 in manner that is similar or equivalent to forward coasting. Thus, during such a jump, sprocket 20 may become disengaged from crank axle 32.

During travel of male cone 82 away from female cone 84, no friction between male cone 82 and bottom bracket 36 or sleeve insert 37 is required for operation. In some cases, friction elements 59 may be disabled during coasting or when crank axle 32 is not being pedaled in forward rotation direction 21. For example, crank axle 32 may be structured or otherwise configured to trigger a braking mechanism that interacts with friction elements 59 when rotated in forward rotation direction 21. Such a braking mechanism may include, for example, a brake shoe, electromagnet or other braking mechanism that may be activated to interact with friction elements 59. Decreasing friction during coasting may enable male cone 82 to continue to move away from female cone 84 after disengagement, thus increasing the slack angle.

Once sprocket 20 is disengaged from crank axle 32, rotation of sprocket 20 is independent of rotation of crank axle 32. Therefore, rear wheel 18 may continue to coast forward, or backward after forward coasting or jumping, without interacting with crank axle 32 and pedals 22. The disengagement may continue until crank axle 32 is rotated through the slack angle in forward rotation direction 21.

It may be noted that once sprocket 20 is disengaged from crank axle 32, crank axle 32 may be rotated backward (opposite forward rotation direction 21) without engaging sprocket 20. Such backward pedaling may cause male cone 82 to travel along external threading 88 further away from female cone 84, thus increasing the slack. Thus, a rider may pedal backward during coasting or jumping where it is desired to increase the slack angle (e.g., to prevent unintentional engagement of sprocket 20 to crank axle 32.

In some cases, a rider may wish to coast backward immediately after forward pedaling (e.g., with no intervening interval of forward coasting or jumping). For example, a rider may wish to pedal up an incline while the speed of forward rotation of rear wheel 18 and of sprocket 20 slows to zero, and then coast backward back down the incline. In this case, the rider may pedal backward briefly when sprocket 20 is stationary. This brief backward pedaling may be a natural or instinctive reaction of the rider under these circumstances. The resulting backward rotation of crank axle 32, together with the friction force that is exerted by friction elements 59 and the interaction of internal threading 82b with external threading 88, may cause male cone 82 to move away from female cone 84. Thus, rear wheel 18 may coast freely in either a backward or forward direction.

In accordance with an embodiment of the present invention, a freecoaster hub may include a planetary gear mechanism. In some cases, a freecoaster hub may be retrofitted with a planetary gear mechanism.

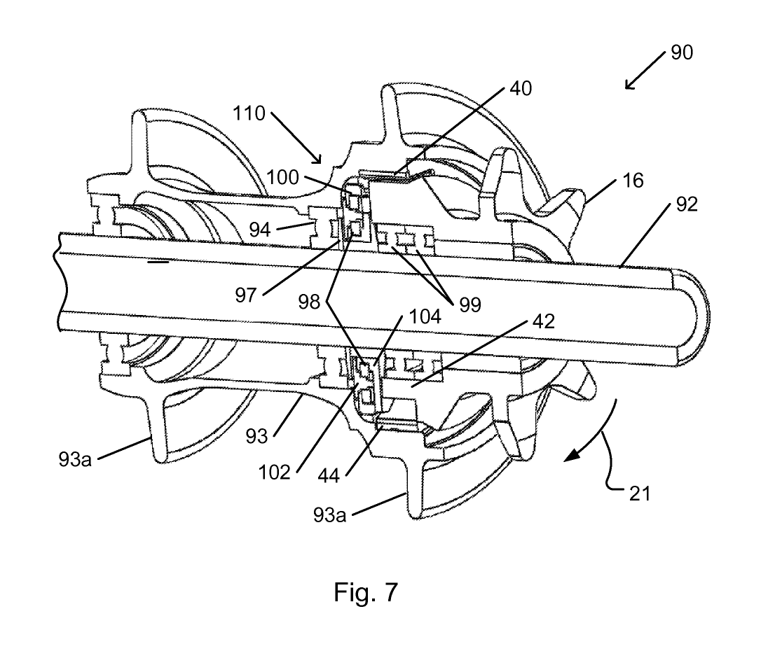

FIG. 7 schematically illustrates a partial cutaway view of a freecoaster hub with a planetary gear, in accordance with an embodiment of the present invention. FIG. 8 schematically illustrates components of a planetary gear assembly of the freecoaster hub shown in FIG. 7.

Hub body 93 (e.g., flanges 93a of hub body 93) of freecoaster hub 90 may be configured to connect to spokes of rear wheel 18. Hub axle 92 is fixed to the bicycle chassis. Hub body 93 may be enabled (e.g., by bearing 94) to rotate about hub axle 92. During pedaling, driver cog 16 may be driven in forward rotation direction 21 by rotation of sprocket 20 via chain 14. Driver cog 16 is directly coupled to pawl housing 42. Pawl housing 42 may be enabled (e.g., by bearings 99) to rotate about hub axle 92. During coasting, rear wheel 18 and hub body 93 may rotate forward or backward, while driver cog 16 remains substantially stationary.

Freecoaster hub 90 may be configured to engage driver cog 16 to hub body 93 during pedaling and to disengage driver cog 16 from hub body 93 during coasting. For example, during pedaling, pawls 44 may be caused to extend outward from pawl housing 42. When pawls 44 extend outward, pawls 44 may engage ratchet ring 40 that is directly coupled to hub body 93. Thus, when pawls 44 extend outward, a torque that is applied to driver cog 16 (via chain 14) may be applied to hub body 93, and thus to rear wheel 18. A retraction mechanism (e.g., similar to retraction structure 43), may maintain pawls 44 in a retracted configuration unless forced or maintained outward, e.g., by rotation against radial projections 112 or by a normal force.

The mechanism for extending pawls 44 includes planetary gear 110. In planetary gear 110, ring gear 100 is directly coupled to hub body 93 so as to rotate together with hub body 93. For example, adapter 116 may be inserted into hub body 93. Adapter 116 may be held to the interior surface of hub body 93 by friction or otherwise (e.g., screws, pins, or otherwise). Adapter 116 may include structure (e.g., grooves that are configured to engage corresponding tabs on ring gear 100) that enables direct coupling to ring gear 100.

Planet gears 98 are mounted on carrier disk 102. Carrier disk cover 103 may be attached to carrier disk 102 to hold planet gears 98 onto carrier disk 102. Carrier disk 102 includes friction elements 96. Friction elements 96 may include axial plungers that are configured to exert an axial normal force on stationary bicycle part 97 (e.g., a stationary portion of bearing 94). Alternatively or in addition, friction elements 96 may be otherwise coupled to stationary bicycle part 97. For example, the coupling may include a magnet (e.g., similar to axial magnetic friction element 59b in FIG. 4D), a ferromagnetic material that is configured to interact with a magnet on stationary bicycle part 97, another mechanical component (e.g., spring, arm, disk, or other mechanical component form applying an axial or radial normal force, e.g., similar to axial spring friction element 59 in FIG. 4C), or another component for resisting rotation of carrier disk 102 relative to stationary bicycle part 97.

Sun gear assembly 104 of planetary gear 110 includes sun gear 114 and radial projections 112. Alternatively or in additions, sun gear 114 may be directly coupled to a separate clutch disk that includes radial projections 112. Each radial projection 112 may be symmetric (e.g., with both sides being shaped in the form of a ramp). Alternatively, each radial projection 112 may have an asymmetric profile, e.g., with a ramp on only one side (e.g., similar to radial projections 62 in FIG. 4B).

When a rider begins to pedal forward, driver cog 16 and pawl housing 42 are rotated in forward rotation direction 21. The forward rotation of pawl housing 42 causes pawls 44 (e.g., tabs of pawls 44) to rotate through the slack angle over ramps 112a of radial projections 112. The rotation of pawls 44 over ramps 112a may extend pawls 44 outward to engage ratchet ring 40 and hub body 93.

Continued forward pedaling continues to rotate pawl housing 42 in forward rotation direction 21. The forward rotation of pawl housing 42 may rotate engaged hub body 93 and, thus, rear wheel 18 in forward rotation direction 21, propelling bicycle 10 in forward bicycle direction 11. The forward rotation of ring gear 100 with hub body 93, together with friction forces that are applied to friction elements 96, may apply a torque to sun gear 114 and to radial projections 112 in a direction that is opposite the direction of rotation of ring gear 100. The applied torque may force radial projections 112 against pawls 44, thus maintaining the engagement of driver cog 16to hub body 93.

During forward coasting, rear wheel 18 and hub body 93 continue to rotate in forward rotation direction 21 while rotation of driver cog 16 ceases. As a result of the directional shape of pawls 44 and ratchet ring 40, ratchet ring 40 may continue to rotate forward relative to pawls 44. The resulting reduction in the normal force may enable the retraction mechanism to retract pawls 44. In some cases, a rider may briefly pedal backward in order to cause pawls 44 to rotate away from radial projections 112, enabling pawls 44 to retract.

During backward coasting, rear wheel 18, hub body 93 and ring gear 100 rotate backward (opposite forward rotation direction 21) while rotation of driver cog 16 ceases. The backward rotation of ring gear 100, together with friction forces that are applied to friction elements 96, may cause sun gear 114 to rotate radial projections 112 away from pawls 44. Thus, the retraction mechanism may retract pawls 44, thus disengaging driver cog from hub body 93. The rotation of sun gear 114 may continue until the maximum slack is attained. Continued backward coasting may maintain the maximum slack.

Use of freecoaster hub 90, which includes a planetary gear, in a bicycle may be advantageous over use of other types of freecoaster hubs. In a typical freecoaster hub, a clutch disk that includes the radial projections is coupled by friction to the bicycle chassis (e.g., axially, via a spring). The slack angle is determined solely by the angular distance between the projections (typically equal to the angular distance between pawls). In freecoaster hub 90, on the other hand, the slack angle is determined by the product of the angle between radial projections 112 and the gear ratio. Maximum slack may be attained and maintained during backward coasting. This additional slack may prevent unintentional (e.g., annoying, or potentially dangerous) engagement of driver cog with hub body 93 due to bumping or to unintentional or involuntary leg movements.

Maximum slack may be determined by the angular separation between radial projections 112, pawls 44, ratchet teeth in ratchet ring 40, and the gear ratio of the planetary gear. In some cases, a gear ratio of the planetary gear of freecoaster hub 90 may be configured so as to provide a predetermined slack angle. For example, diameters or numbers of cog teeth on one or more of ring gear 100, planet gears 98 and sun gear 114 may be selected in accordance with a desired gear ratio.

In some cases, freecoaster hub 90 may be assembled by retrofitting a planetary gear assembly to an existing freecoaster hub. For example, the planetary gear assembly may include ring gear 100, carrier disk 102 (with attached planetary gears 98 and friction elements 96), and sun gear assembly 104 with sun gear 114 and radial projections 112). In some cases, the planetary gear assembly may also include stationary bicycle part 97 or another component that is intended for coupling to the bicycle chassis (e.g., to a non-rotating part of a bearing) or to hub axle 92. Prior to installation of the planetary gear assembly, an existing clutch disk and related components (e.g., a friction spring) may be removed. A planetary gear assembly may be configured with dimensions that enable replacement of the existing parts without further modification of the hub. Therefore, the planetary gear assembly may be provided with suitable spacers that enable direct replacement of previous components. A particular planetary gear assembly may be designed to be retrofit in a particular type or model of freecoaster hub.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A drive mechanism to enable a bicycle to coast forward or backward, the device comprising:
a ratchet ring that is directly coupled to a sprocket of the bicycle;
a pawl housing that is directly coupled to a crank axle of the bicycle, the housing comprising a plurality of pawls that are distributed about a perimeter of the housing, the pawls being extendible outward from the perimeter of the housing to engage the ratchet ring to rotate the sprocket when the crank axle is rotated by forward pedaling; and
a clutch disk that includes a plurality of radial projections, each radial projection configured to extend outward a pawl of said plurality of pawls when that pawl is rotated to that radial projection by forward rotation of the crank axle, the clutch disk being coupled to a friction element that resists rotation of the clutch disk relative to a chassis of the bicycle.

2. The mechanism of claim 1, wherein the pawl housing comprises a retraction mechanism to retract a pawl of said plurality of pawls when not extended outward by a radial projection of said plurality of radial projections.

3. The mechanism of claim 2, wherein the retraction mechanism comprises a mechanism that is selected from a group of mechanisms consisting of an elastic ring, a magnet and a spring.

4. The mechanism of claim 2, configured such that the retraction mechanism retracts the pawl when no forward torque is applied to the crank axle.

5. The mechanism of claim 1, wherein the clutch disk is directly coupled to the friction element.

6. The mechanism of claim 1, wherein the clutch disk is coupled to the friction element via a planetary gear mechanism.

7. The mechanism of claim 6, wherein the clutch disk is directly coupled to a sun gear of the planetary gear mechanism, the friction element is directly coupled to a carrier disk of the planetary gear mechanism, and a ring gear of the planetary gear mechanism is directly coupled to the sprocket.

8. The mechanism of claim 6, wherein the planetary gear mechanism is configured to provide a predetermined slack angle.

9. The mechanism of claim 1, wherein the friction element comprises a radial plunger.

10. The mechanism of claim 1, wherein the friction element comprises an axial spring, magnet, or plunger.

11. The mechanism of claim 1, wherein a pawl of said plurality of pawls is extendible by rotation about an axis.

12. The mechanism of claim 11, wherein a direction of rotation of the pawl relative to the pawl housing is selectable.

13. The mechanism of claim 11, wherein a face of a tooth of the ratchet ring forms an acute angle with a local tangent to the ratchet ring.

14. A drive mechanism to enable a bicycle to coast forward or backward, the mechanism comprising:
a first cone and a second cone, one of the cones being a female cone and the other of the cones being a male cone, wherein
the first cone is directly coupled to a sprocket of the bicycle and
the second cone, having internal threading, is configured to travel along corresponding external threading on a crank axle of the bicycle, and includes a friction element that resists rotation of that cone relative to a chassis of the bicycle, the threading oriented such that the second cone is caused to travel toward the first cone when a forward torque is applied to the crank axle by forward pedaling so as to cause the cones to engage so as to apply a forward torque to the sprocket.

15. The mechanism of claim 14, wherein the second cone is configured to disengage from the first cone during forward coasting when the sprocket is connected via a chain to a driver cog that is fixed to a wheel of the bicycle.

16. The mechanism of claim 14, wherein the first cone comprises the female cone and the second cone comprises the male cone.

17. A freecoaster hub device to enable a bicycle to coast forward or backward, the device comprising:
a ratchet ring that is directly coupled to a hub body of a wheel of the bicycle;
a pawl housing that is directly coupled to a driver cog of a wheel of the bicycle, the housing comprising a plurality of pawls that are distributed about a perimeter of the housing, the pawls being extendible outward from the perimeter of the housing to engage the ratchet ring to rotate the hub body when the driver cog is rotated forward; and
a clutch disk that includes a plurality of radial projections, each radial projection configured to extend a pawl of said plurality of pawls when that pawl is rotated to that radial projection by forward rotation of the driver cog, the clutch disk being coupled by a planetary gear to a friction element that resists rotation of the clutch disk relative to a chassis of the bicycle.

18. The device of claim 17, wherein the clutch disk is directly coupled to a sun gear of the planetary gear mechanism, the friction element is directly coupled to a carrier disk of the planetary gear mechanism, and a ring gear of the planetary gear mechanism is directly coupled to the hub body.

19. The device of claim 17, wherein a gear ratio of the planetary gear mechanism is configured to provide a predetermined slack angle.

20. The device of claim 17, wherein the friction element comprises a plunger, a spring or a magnet.
